(19) United States
(12) Patent Application Publication
(10) Pub. No.: US 2014/0353971 A1
(43) Pub. Date: Dec. 4, 2014

(54) MAGNETIC BEARINGS AND RELATED SYSTEMS AND METHODS

(71) Applicant: Kent Davey, Edgewater, FL (US)

(72) Inventor: Kent Davey, Edgewater, FL (US)

(73) Assignee: OCEANA ENERGY COMPANY, Washington, DC (US)

(21) Appl. No.: 14/239,023

(22) PCT Filed: Aug. 14, 2012
(86) PCT No.: PCT/US2012/050814

§ 371 Date: Jun. 12, 2014

Related U.S. Application Data
(60) Provisional application No. 61/523,594, filed on Aug. 15, 2011.

(51) Int. Cl. H02K 7/09; H02K 7/18

(52) U.S. Cl. CPC H02K 7/09; H02K 7/1823
USPC 290/52; 310/90.5

(57) ABSTRACT

An energy recovery system may comprise a stationary structure and a rotatable structure configured to rotate relative to the stationary structure about an axis of rotation. The energy recovery system may also comprise at least one blade member mounted to and extending radially outward from the rotatable structure, the at least one blade member being configured to interact with fluid currents flowing in a direction substantially parallel to the axis of rotation to cause the rotatable structure to rotate about the axis of rotation. The energy recovery system may further comprise a magnetic suspension system comprising a plurality of magnets and a plurality of coils, wherein the plurality of magnets and the plurality of coils provide a magnetic force that substantially maintains an axial and radial position of the rotatable structure and the stationary structure as the rotatable structure rotates about the stationary structure.

This application claims the benefit of U.S. Provisional Application No. 61/523,594, filed Aug. 15, 2011, which is incorporated by reference herein in its entirety.

### TECHNICAL FIELD

The present disclosure relates generally to magnetic bearings that are useful to provide support between two structures that move relative to each other. In particular, the present disclosure relates to magnetic bearings used in energy recovery systems that convert kinetic energy from fluid flow, for example, from liquid currents, to another form of energy, for example, electricity and/or hydrogen production.

### BACKGROUND

The section headings used herein are for organizational purposes only and are not to be construed as limiting the subject matter described in any way.

Electricity generation using systems that convert energy from fluid currents, for example, wind or water currents is well known. Tidal power exploits the movement of water caused by tidal currents, or the rise and fall in sea levels due to tides. As the waters rise and then fall, a flow, or current, is generated. Additional forms of differential pressure, such as, for example, that are created by dams, also can cause water to flow and create water speeds sufficient to enable the conversion of energy associated with the water's flow to other useful forms of energy.

Tidal power, which relies on the natural movement of currents in a body of liquid (e.g., water), is classified as a renewable energy source. Unlike other renewable energy sources, such as wind and solar power, however, tidal power is reliably predictable. Water currents are a source of renewable power that is clean, reliable, and predictable years in advance, thereby facilitating integration with existing energy grids. Additionally, by virtue of the basic physical characteristics of water (including, e.g., seawater), namely, its density (which can be 832 times that of air) and its non-compressibility, this medium holds unique, “ultra-high-energy-density” potential, in comparison to other renewable energy sources, for generating renewable energy. This potential is amplified once the volume and flow rates present in many coastal locations and/or useable locations worldwide are factored in.

Tidal power, therefore, may offer an efficient, long-term source of pollution-free electricity, hydrogen production, and/or other useful forms of energy that can help reduce the world's current reliance upon petroleum, natural gas, and coal. Reduced consumption of fossil fuel resources can in turn help to decrease the output of greenhouse gases into the world's atmosphere.

Some recent tidal power schemes use the kinetic energy of moving water to power turbine-like structures. Such systems can act like underwater windmills, and have a relatively low cost and ecological impact. In some energy recovery systems, fluid flow interacts with blades that rotate about an axis and that rotation is harnessed to thereby produce electricity or other forms of energy. While many such energy recovery systems employ blades or similar structures mounted to a central rotating shaft, other systems utilize a shaftless, open-center configuration with the blades being supported by other means.

Energy recovery systems can pose challenges relating to the stress and/or strain on the various components of such systems resulting from the interaction of the relatively strong forces associated with fluid flow (e.g., moving currents). For example, as a fluid current (e.g., tidal current) interacts with an energy recovery system, there is an amount of thrust that acts on the various components, which may cause displacement of one or more components, particularly components configured to move relative to stationary components. Additional challenges may arise from such energy recovery systems' reliance on relative rotational movement of components to produce energy. For example, friction and/or drag associated with rotational movement of such systems may hinder efficiency of the system. Moreover, such relative motion can, for example, cause wear of such components, which may be exacerbated when an energy recovery system is placed underwater, for example, in a sea or other body of water containing relatively harsh, deteriorative substances (e.g., salt).

It may, therefore, be desirable to provide an energy recovery system and method that can withstand the forces (e.g., axial and/or radial) associated with fluid flow interacting therewith. It also may be desirable to provide an energy recovery system and method that results in relatively low friction and/or drag effect to thereby promote overall efficiency of energy conversion. It also may be desirable to provide an energy recovery system and method that reduces wear of moving components by, for example, having a magnetic suspension system. Further, it may be desirable to provide an energy recovery system and method that provides a magnetic support mechanism (e.g. a magnetic bearing) between components that move relative to each other that also may serve as a mechanism to produce electricity.

### SUMMARY

The present disclosure may solve one or more of the above-mentioned problems and/or achieve one or more of the above-mentioned desirable features. Other features and/or advantages may become apparent from the description which follows.

In accordance with an exemplary embodiment of the present disclosure, an energy recovery system may comprise a stationary structure and a rotatable structure configured to rotate relative to the stationary structure about an axis of rotation. The energy recovery system may also comprise at least one blade member mounted to and extending radially outward from the rotatable structure, the at least one blade member being configured to interact with fluid currents flowing in a direction substantially parallel to the axis of rotation to cause the rotatable structure to rotate about the axis of rotation. The energy recovery system may further comprise a magnetic suspension system comprising a plurality of magnets and a plurality of coils, wherein the plurality of magnets and the plurality of coils provide a magnetic force that substantially maintains an axial and radial position of the rotatable structure and the stationary structure as the rotatable structure rotates about the stationary structure.

In accordance with an additional exemplary embodiment of the present disclosure, a method of supporting a rotating structure may comprise rotating a rotating structure relative to a stationary structure about an axis of rotation, wherein the rotating causes relative movement of a magnetic field source and an electrically conductive element. The method may further comprise generating a magnetic force resulting from the relative movement of the magnetic field source and electrically conductive element, wherein the magnetic force is sufficient to substantially maintain a position of the rotatable structure relative to the stationary structure during the rotating.

Additional objects and advantages will be set forth in part in the description which follows, and in part will be obvious from the description, or may be learned by practice of the present disclosure. At least some of the objects and advantages of the present disclosure may be realized and attained by means of the elements and combinations particularly pointed out in the appended claims.

It is to be understood that both the foregoing general description and the following detailed description are exemplary and explanatory only and are not restrictive of the invention, as claimed. It should be understood that the invention, in its broadest sense, could be practiced without having one or more features of these exemplary aspects and embodiments.

### BRIEF DESCRIPTION OF DRAWINGS

The accompanying drawings, which are incorporated in and constitute a part of this specification, illustrate some exemplary embodiments of the present disclosure and together with the description, serve to explain certain principles. In the drawings,

FIG. 1 is a plan view of an exemplary embodiment of an energy recovery system in accordance with the present disclosure;

FIG. 2 is a partial cross-sectional view of the energy recovery system of FIG. 1 taken through line 2-2 in FIG. 1;

FIG. 3 is a partial perspective view of an exemplary embodiment of a magnetic suspension system utilizing magnetic bearing mechanisms in accordance with the present disclosure;

FIG. 4 is an enlarged view of a section of the magnetic suspension system of FIG. 3;

FIG. 5 is a magnetization field plot for an exemplary magnetic suspension system having a configuration like that in FIG. 3;

FIG. 6 is plan view of an exemplary embodiment of a coil in accordance with the present disclosure.

FIG. 7 is a partial perspective view of an exemplary embodiment of a back plate in accordance with the present disclosure;

FIG. 8 is a partial cross-sectional view of an additional exemplary embodiment of an energy recovery system in accordance with the present disclosure;

FIG. 9 is a partial perspective view of another exemplary embodiment of a magnetic suspension system utilizing magnetic bearing mechanisms in accordance with the present disclosure; and

FIG. 10 is a plan view of the magnetic suspension system of FIG. 9.

### DESCRIPTION OF EXEMPLARY EMBODIMENTS

Reference will now be made in detail to various exemplary embodiments of the present disclosure, examples of which are illustrated in the accompanying drawings. Wherever possible, the same reference numbers will be used throughout the drawings to refer to the same or like parts.

Although the following description focuses on energy recovery systems, such as for use in liquid environments, the principles and magnetic bearing mechanisms disclosed herein are not limited to such applications, and can be applied to a variety of applications, in which counteracting forces may be an issue to support the motion of one structure relative to another structure, including, for example, wind turbines, drill shafts, precision lathes, and other similar structures.

Various exemplary embodiments of the present disclosure contemplate an energy recovery system configured to interact with fluid streams, such as, for example, tidal currents, that utilizes an open-center configuration and relative movement of components of the system to convert kinetic energy from fluid flow into other useful forms of energy, such as, for example, electricity and/or hydrogen production. In various exemplary embodiments, the present disclosure contemplates one or more blade members supported by and extending radially outwardly and/or inwardly from a rotatable structure that is mounted to rotate relative to a stationary structure. Fluid flowing past the system may interact with the blades to cause rotation of one or more blades relative to the stationary structure. In various exemplary embodiments, as shown in the figures, the rotatable structure and the stationary structure can be closed-loop structures (e.g., having a ring or elliptical configuration). Further, either of the rotatable closed-loop or stationary closed-loop structures of the present disclosure may be in the form of a unitary closed-loop structure or may comprise a plurality of modular segments (e.g., substantially arcuate-shaped segments) connected together to form an integral closed-loop structure. As would be understand by those of ordinary skill in the art, however, the embodiments shown are exemplary only and are not intended to be limiting of the present disclosure and claims. Accordingly, the rotatable structure and the stationary structure may comprise various shapes and/or configurations.

Although in various exemplary embodiments shown and described herein, a plurality of blades are supported by the rotatable structure, any number of blades, including one, may be supported by the rotatable structure. Moreover, blades may extend radially outward from, radially inward toward, or both radially outward and radially inward toward a center of the open-center energy recovery system.

Open-center energy recovery systems, such as those in accordance with the present disclosure, may offer the ability to scale up or down the overall size of the system as the gage, length, and path configuration of the stationary structure can vary greatly. Likewise, the strength, size, and shape of the blades also may vary significantly. This is in contrast with central shaft systems, where the size of the blades can be somewhat limited due to the stresses associated with longer blades supported by a central rotating shaft. In exemplary embodiments of the present disclosure, the length and size of the blades can vary greatly since they are mounted to a rotatable structure that is disposed at a distance from the center of rotation of the device which offers increased stability compared to a central shaft. Therefore, the entire device can be scaled up or down to accommodate varying site characteristics and other requirements and/or to achieve desired results.

Support and movement of the rotatable structure relative to and along the stationary structure may be accomplished by one or more bearing mechanisms as disclosed in International Publication No. WO 2011/059708 A2, filed on Oct. 27, 2010, which is incorporated herein by reference in its entirety. Reference is also made to U.S. Pat. Nos. 7,453,166 and 7,604,454, respectively issued on Nov. 18, 2008 and Oct. 20, 2009, each of which is incorporated by reference herein in its entirety, and which discloses various other configurations and embodiments of open-center energy recovery systems.

In various exemplary embodiments of the present disclosure, one or more magnetic bearing mechanisms may be provided to substantially maintain the relative position, in both an axial and radial direction, of the rotatable structure and the stationary structure. Thus, magnetic bearing mechanisms in accordance with the present disclosure may provide a passive, stable axial and radial suspension, without, for example, the need for transducers or gap control. To provide an axial restoring force (e.g., to offset axial flow thrust forces) and a radial restoring force (e.g., to provide lift) between the rotatable structure and the stationary structure, magnetic bearing mechanisms in various exemplary embodiments in accordance with the present disclosure may comprise a plurality of magnets and a plurality of coils. In various embodiments, for example, the plurality of magnets may be substantially arranged in a Halbach type array, such as, for example, a partial Halbach array, and the plurality of coils may comprise a plurality of shorted coils. In various additional exemplary embodiments of the present disclosure, the magnetic bearing mechanisms may also serve as a mechanism to produce electricity, for example by further comprising elongated generator magnets and generator coils.

As used herein, the term “magnetic bearing mechanism” refers to various components used for magnetic suspension, such as, for example, to stabilize and support a load using magnetic levitation, and may include, for example, magnets having magnetic fields associated therewith and coils having an induced magnetism. Thus, magnetic bearing mechanisms may support moving structures, such as, for example, a rotating structure with relation to a stationary structure, without physical contact. In other words magnetic bearing mechanisms in accordance with the present disclosure can levitate and axially support a rotating structure with relation to a stationary structure, and permit relative rotation of the rotating structure with very low friction and no mechanical wear.

As would be understood by those of ordinary skill in the art, as used herein, the term “Halbach type array” refers to a rotating pattern of permanent magnets, which augments the magnetic field on one side of the array, while cancelling the magnetic field on the other side of the array, thereby creating a “one-sided flux”. Non-limiting, exemplary Halbach type arrays may include, for example, partial Halbach arrays, in which the magnetization direction of the permanent magnets changes in discrete jumps from one magnet to its neighboring magnet, such as, for example, using a 90 degree rotation angle change. Thus, exemplary embodiments of the present disclosure may include, for example, but are not limited to, 90 degree partial Halbach arrays (which have a 90 degree rotation pattern) and 45 degree Halbach arrays (which have a 45 degree rotation pattern). The present disclosure contemplates, however, using any type of Halbach array known to those of ordinary skill in the art.

As would be further understood by those of ordinary skill in the art, as used herein, the term “shorted coil” refers to a coil that allows current to flow in a closed path when induced by a changing magnetic field. In other words, in various exemplary embodiments, a shorted coil comprises an area of low resistance, which creates a short circuit through which current may continuously flow around the coil. In various exemplary embodiments of the present disclosure, for example, a shorted coil may comprise a coil that is formed from an electrically conductive material, such as, for example, a copper wire, that is wound in multiple turns. In various exemplary embodiments, the coil may be shorted by, for example, soldering the ends of the wire together. Those of ordinary skill in the art would understand, however, that shorted coils in accordance with the present disclosure may have various configurations, be formed of various electrically conductive materials such as, for example, Litz wire, and may be shorted using various techniques and/or methods as understood by those of ordinary skill in the art.

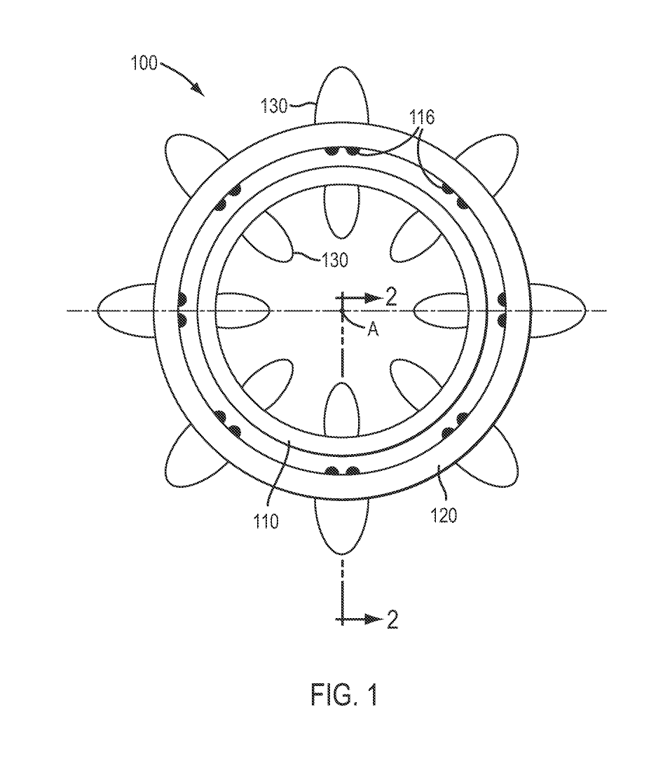

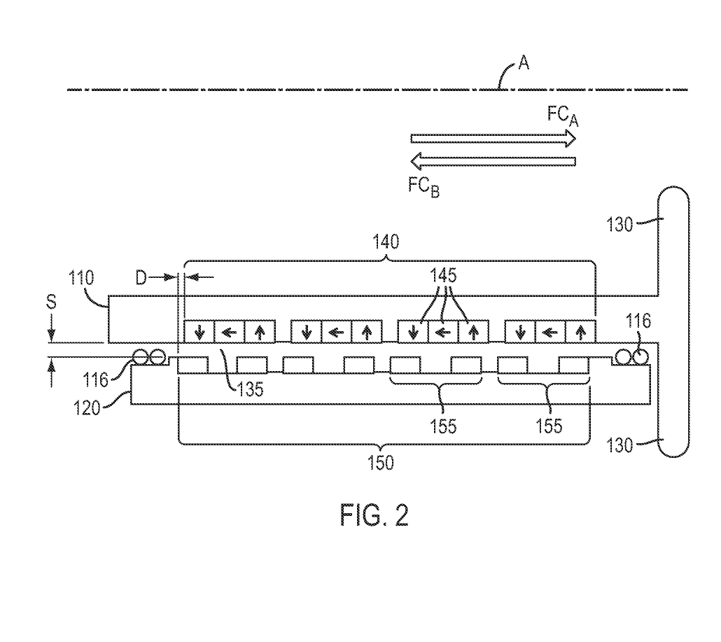

With reference now to FIGS. 1 and 2, a schematic plan view and cross-sectional view (taken through line 2-2 of the energy recovery system of FIG. 1) of an exemplary embodiment of an energy recovery system 100 having an open center configuration is shown. The energy recovery system 100 includes a rotatable structure 110 to which one or more blade members 130 (a plurality being shown in FIG. 1) are mounted. The rotatable structure 110 is rotatably mounted relative to (e.g., within the periphery thereof in the exemplary embodiment of FIG. 1) a stationary structure 120. The blade members 130 are configured and positioned relative to the rotatable structure 110 such that fluid currents may interact with the blade members 130 to cause the rotatable structure 110 with the blade members 130 carried thereby to rotate in a manner with which those ordinarily skilled in the art are familiar. For example, the blade members 130 may be hydrofoils configured to interact with fluid currents (designated as FC_{A} and FC_{B} in FIG. 2) moving in a direction substantially perpendicular to a plane of rotation of the blade members 130 and the rotatable structure 110 (and substantially parallel to an axis A of rotation of the blade members 130 and rotatable structure 110). In other words, in the orientation of the system 100 in FIG. 1, the blade members 130 may be configured to interact with fluid currents FC_{A} and/or FC_{B} having a component moving in a direction substantially perpendicular to the plane of the drawing sheet.

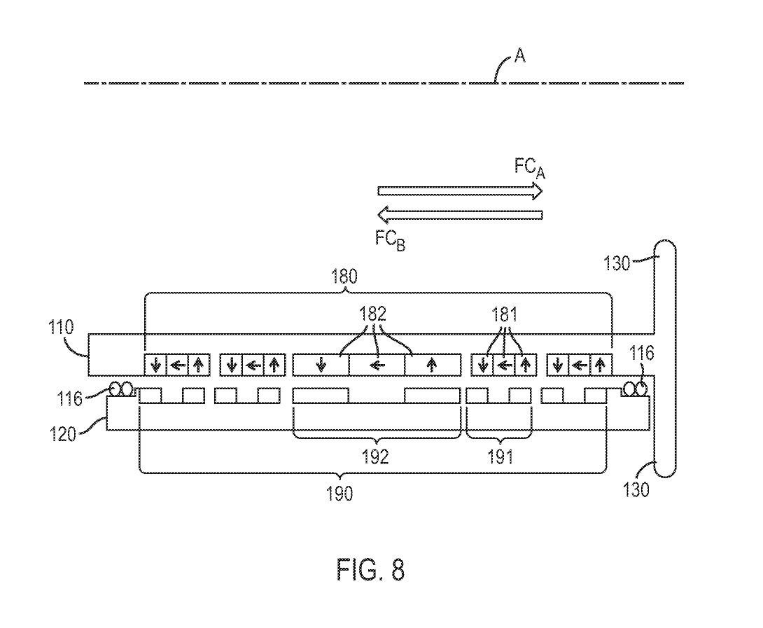

The rotational movement caused by interaction of fluid currents with the blade members 130 may be converted to another form of energy, such as, for example, electricity and/or hydrogen production utilizing, for example, a generator magnet and a generator coil, such as, for example, a stator winding (see, e.g., generator coil 182 in FIG. 8). Such conversion of the rotational movement to another form of energy may occur via numerous techniques those having skill in the art would be familiar with. Reference also is made to U.S. Pat. No. 7,453,166 and U.S. Pat. No. 7,604,454, incorporated herein by reference in their entirety.

As disclosed in International Publication No. WO 2011/059708 A2 incorporated by reference herein, to rotatably mount the rotatable structure relative to the stationary structure, an energy recovery system may include one or more sets of bearing mechanisms, such, as for example, one or more sets of magnetic bearing mechanisms. As shown in FIG. 2, for example, in accordance with the present disclosure, to mount the rotatable structure 110 relative to the stationary structure 120, the energy recovery system 100 of FIG. 1 may include one or more sets of passive magnetic bearing mechanisms 140 and 150. The magnetic bearing mechanisms 140 and 150 may be configured to permit the rotatable structure 110 to rotate relative to the stationary structure 120 in a substantially stable axial position and a substantially stable radial position. In this way, for example, the magnetic bearing mechanisms 140 and 150 can provide a passive axial restoring support and a passive radial stabilizing force for the structures 110, 120. For example, the magnetic field between the bearing mechanisms 140 and 150 may be sufficient to substantially retard relative movement of the rotatable structure 110 and/or the stationary structure 120 in the axial direction as a result of the force associated with the fluid current (e.g., the thrust of the fluid current) acting thereon. Furthermore, the magnetic field between the bearing mechanisms 140 and 150 may also be sufficient to provide a lift force between the rotatable structure 110 and the stationary structure 120 in the radial direction as a result of the repulsive forces associated with the bearing mechanisms 140 and 150 in order to maintain a radial gap 135 between the structures 110 and 120.

In various exemplary embodiments, as shown in FIG. 2, magnetic bearing mechanisms 140 and 150 include a plurality of magnets 145 and a plurality of coils 155, respectively. In an exemplary embodiment, the magnets 145 may be substantially arranged in a Halbach type array, such as, for example a 90 degree partial Halbach array as illustrated in FIG. 2 comprising a rotating pattern of permanent magnets, wherein the arrows demonstrate the orientation of each magnet's magnetic field. In various additional embodiments, the coils 155 can be shorted coils, such as, for example, shorted copper coils. In various embodiments, the coils 155 may, for example, be constructed of Litz wire or a twisted multi-turn wire to minimize the skin and proximity effect of the induced current in the coils as would be understood by those of ordinary skill in the art.

As would be understood by those of ordinary skill in the art, as the rotatable structure 110 rotates relative to the stationary structure 120, the changing movement of the magnetic fields of the magnets 145 through the conductive materials of the coils 155 induces a current in the coils 155 that is opposite to the magnetic fields of the magnets 145. In other words, a current will be induced in the stationary coils 155 by the movement of the magnets 145 with respect the coils 155. The magnets 145 and coils 155, therefore, may each provide a source of magnetomotive force (MMF), wherein the coupling between the magnets 145 and coils 155 is sinusoidal. Thus, as shown in FIG. 2, when the magnet arrays formed by magnets 145 on the rotatable structure 110 are displaced by a displacement D with respect to the coils 155 on the stationary structure 120, radial air gap fields provide an axial restoring force. In other words, displacement of the magnets 145 with respect to the coils 155 creates a restoring force as the magnets attempt to align themselves with the coils. Thus, the magnets 145 induce a force in the coils 155 to re-center the coils over the magnets 145 into a position where they link no net flux. This alignment force of the magnets 145 in turn counteracts the thrust of the fluid, which produces an axial thrust on the energy recovery system 100 in the direction of the fluid flow (i.e., FC_{A} or FC_{B}).

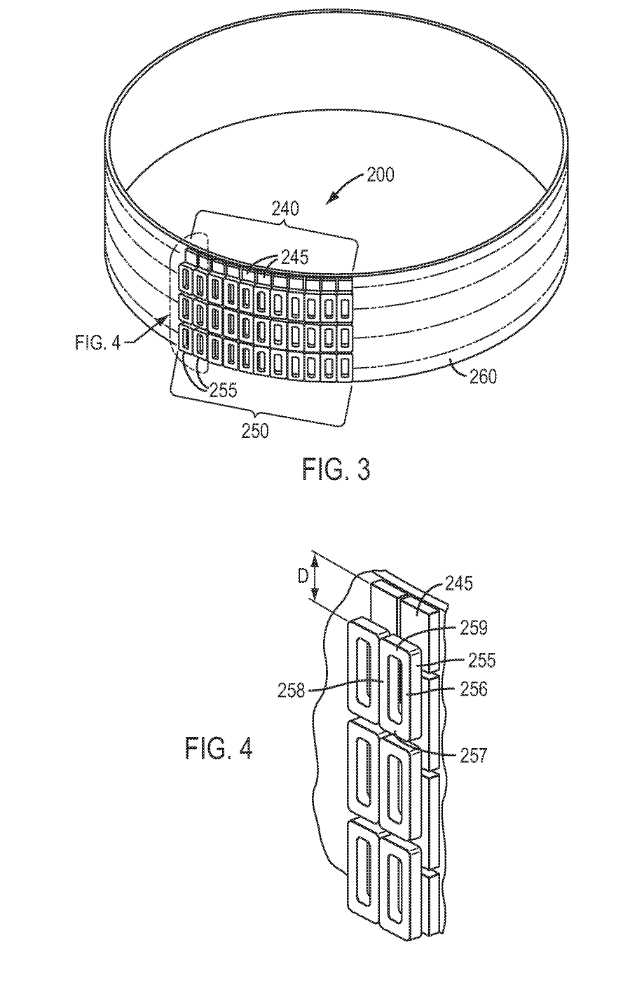

To further explain the restoring force between the magnets and coils discussed above, with reference to FIGS. 3 and 4, detailed views of an exemplary embodiment of a magnetic suspension system 200 utilizing magnetic bearing mechanisms in accordance with the present disclosure are shown. As illustrated in FIGS. 3 and 4, the magnetic suspension system 200 may include one or more sets of passive magnetic bearing mechanisms 240 and 250, respectively comprising a plurality of magnets 245 and a plurality of coils 255. As perhaps illustrated best in FIG. 4, when the magnets 245 are displaced by a displacement D (wherein D is the distance between the top the coils 255 and the top of the magnets 245) with respect to the coils 255, the induced currents in the coils 255 from the rotation of the magnets 245 with respect to the coils 255 will result in an axial restoring force between the magnets 245 and coils 255 tending to re-center the magnets 245 with respect to the coils 255. As would be understood by those of ordinary skill in the art, in such a configuration, all four legs 256, 257, 258, 259 of each coil 255 will experience a force to re-center the array. Further, the coils 255 also have a repulsive component to push the coils 255 away from the magnets 245 (i.e., a levitating force) as explained below. Thus, the magnets 145, 245 and the coils 155, 255 of the above exemplary embodiments function respectively as suspension magnets and suspension coils to provide both axial restoring and radial stabilizing forces.

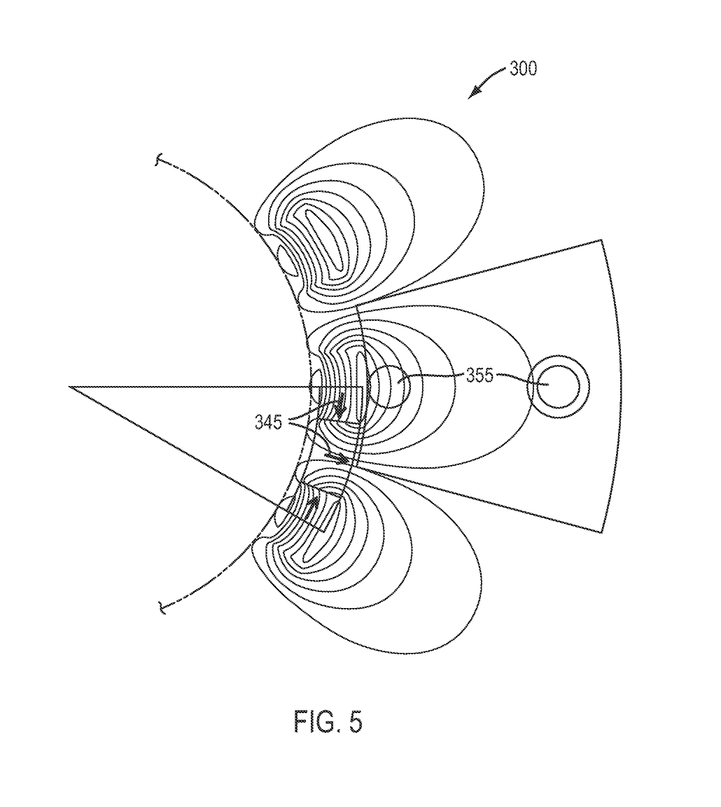

FIG. 5, for example, illustrates the magnetization field plot for an exemplary magnetic suspension system 300 having a configuration like that in FIGS. 3 and 4. As would be understood by those of ordinary skill in the art, a magnetic suspension system, such as, for example, illustrated in FIGS. 3 and 4 may, for example, be analyzed using boundary element and finite element codes, wherein periodic (repeating) boundary conditions are employed to simplify the calculations. FIG. 5, for example, illustrates the magnetic field lines for one section of an exemplary magnetic suspension system 300 comprising magnets 345 and coils 355. As would be understood by those of ordinary skill in the art, the magnetic field lines shown that are generated by the magnets 345 can be used to compute the flux linkage (or the product of the number of turns in the coils 355 and the magnetic flux from the magnets 345 passing through the coils 355) between the magnets 345 and coils 355. The flux linkage may then be used to predict the current induced in the coils 355, and thus the restoring and levitating forces between the magnets 345 and coils 355. The rotation speed of the magnets 345 will dictate the rate of change of the flux linkage with time, and thus the current induced in the coils 355. Knowing the resistance and inductance of the coils 355 permits the forces on the coils 355 to be determined. Thus, using the magnetization field plot shown in FIG. 5, and assuming a magnet weight for a 48 inch diameter full assembly (e.g., an energy recovery system 100 comprising a rotatable structure 110) of 216 pounds, it would be expected based on performing the above calculations that the magnetic suspension system 300 has an axial restoring force of about 1530 pounds with an axial displacement of less than or equal to about ⅝ inches when the magnets 345 are rotating at about 60 rpm (e.g., on the rotatable structure 110).

Those of ordinary skill in the art would understand that the above magnetic suspension system in accordance with one exemplary embodiment was analyzed for exemplary purposes only and that energy recovery systems, incorporating magnetic suspension systems in accordance with the present disclosure, may have various sizes, shapes, and/or configurations, including, for example, various sizes, shapes, and/or configurations of rotatable and stationary structures, having respectively various numbers, sizes, shapes and/or configurations of magnetic bearing mechanisms. Furthermore, magnetic suspension systems utilizing magnetic bearing mechanisms in accordance with the present disclosure may have various types, numbers, sizes, shapes, and/or configurations of magnets and coils. Based on the teachings of the present disclosure, it is therefore within the ability of one skilled in the art to determine a magnetic suspension system and bearing mechanisms design to achieve a desired axial restoring and radial stabilizing (e.g., levitating) force, and the present disclosure is not intended to be limited to the exemplary embodiments shown and described herein.

With reference again to FIG. 2, as would be understood by those of ordinary skill in the art, the force between a single coil 155 and its nearest magnet 145 is repulsive. As the rotatable structure 110 rotates about the stationary structure 120, for example, above a certain speed/frequency of rotation, the induced currents in the coils 155 are of a phase that yields a repulsive force. Accordingly, as arranged, the magnets 145 and coils 155 are configured to repel each other to substantially maintain a spacing S between the rotatable structure 110 and the stationary structure 120. Thus, the magnetic field between the bearing mechanisms 140 and 150 is also sufficient to provide lift of the rotatable structure 110 relative to the stationary structure 120 in the radial direction as a result of the repulsive forces associated with the magnets 145 and coils 155. In other words, the magnetic field is sufficient to provide a levitating force in a radial direction so that the rotatable and stationary structures 110, 120 are able to rotate relative to each other while substantially maintaining the spacing S between the two structures. As would be understood by those of ordinary skill in the art, a radial repulsive force is expected for all magnets rotating past shorted coils. This repulsive force will get stronger as the gap between the magnets 145 and the shorted coils 155 is reduced, thereby generating a restoring force radially across the structures 110, 120.

Due to their configuration and central location within the energy recovery system 100, the magnetic bearing mechanisms 140 and 150 are bidirectional and may therefore accommodate flow in either direction. In other words, in the orientation of the system in FIG. 2, the blade members 130 may be configured to interact with fluid currents FC_{A} and/or fluid currents FC_{B}, each having a component moving in a direction substantially perpendicular to the plane of the drawing sheet. Further, as above, the magnetic bearing mechanisms 140 may comprise various Halbach type arrays and the magnetic bearing mechanisms 150 may comprise various types and/or configurations of coils, and those having skill in the art would understand how to modify and offset the bearing mechanisms 140 and 150 with respect to each other to permit the rotatable structure 110 to rotate relative to the stationary structure 120 in a substantially stable axial position and a substantially stable radial position by providing a sufficient axial restoring force and radial lift force. The structures 140 and 150 shown are schematic representations only. Those having ordinary skill in the art will appreciate that the number, shape, spacing, size, magnetic field strength (e.g., of magnets 145), radial thickness (e.g., of coils 155), displacement and other properties of the bearing mechanisms 140 and 150 may be modified and selected based on various factors such as the size and weight of the rotatable and stationary structures 110, 120, the required restoring and bearing forces, and other factors based on the desired application.

By way of example only, to support the rotatable structure 110 relative to the stationary structure 120 at low rotation speeds and/or when the rotatable structure 110 is stationary and there is no rotation of the magnets 145 with respect to the coils 155, and therefore no induced current in the coils 155, the energy recovery system 100 of FIGS. 1 and 2 may further include one or more sets of mechanical bearings. In various embodiments of the present disclosure, for example, the energy recovery system 100 may further include touchdown bearings, such as for example, conventional sealed roller bearings 116 (a plurality of sets being depicted in the exemplary embodiment of FIGS. 1 and 2) to support the structures 110 and 120 at low and/or zero rotation speeds. In various additional exemplary embodiments, the bearings 116 may be eliminated in favor of low-friction (e.g., ceramic, Teflon, and/or various thermoplastic polymer) surfaces (not shown); alternatively, a combination of roller bearings and low-friction surfaces may be used. As would be understood by those of ordinary skill in the art, to provide adequate support, such bearings can be positioned with a radial air gap that is larger than the anticipated running air gap of the structures 110 and 120.

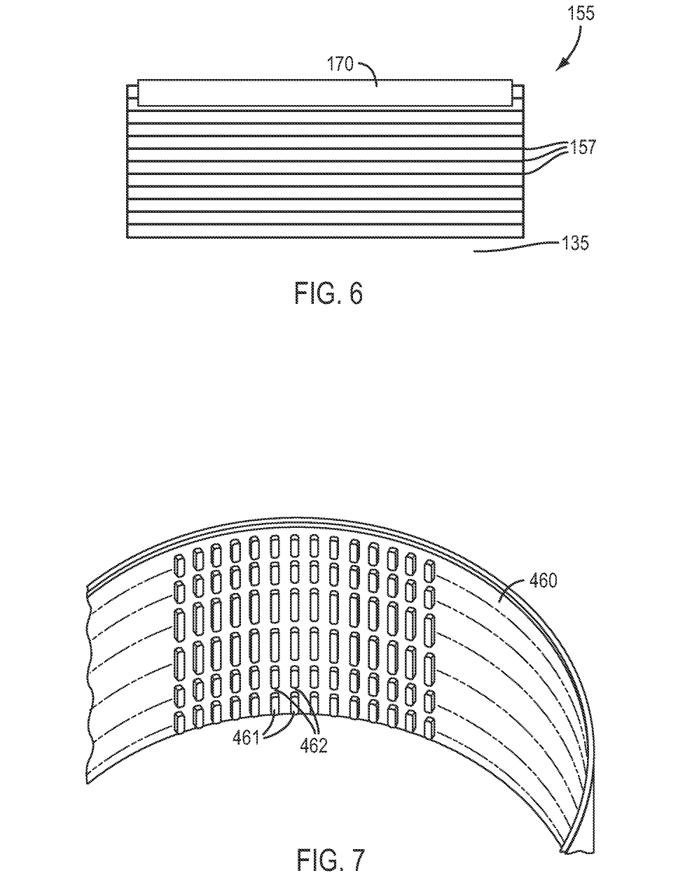

Various additional embodiments of the present disclosure contemplate enhancing the inductance of the coils 155 to allow suspension to occur (between the structures 110 and 120) at lower rotation speeds. As shown in FIG. 6, which illustrates a plan view of a coil 155, in various embodiments, for example, the coils 155 may each comprise a plurality of turns 157, wherein at least one of the turns 157 is surrounded by a ferromagnetic sleeve 170, such as, for example, a ferrite sleeve, to enhance the inductance of the coil 155. In various embodiments, for example, the ferromagnetic sleeve 170 may be positioned over turns 157 that are farthest away from the air gap 135 between the structures 110 and 120 (the outermost return coils 157), as illustrated in FIG. 6. In such a configuration, as would be understood by those of ordinary skill in the art, the ferromagnetic sleeve 170 may be less likely to contribute to the destabilizing radial forces exerted on the structures.

Various additional exemplary embodiments of the present disclosure contemplate utilizing a non-magnetizable back plate, such as, for example, a composite back plate formed from a resin filler or fiberglass, for each of the magnetic bearing mechanisms (e.g., magnetic bearing mechanisms 140 and 150). Those of ordinary skill in the art would understand, for example, that the presence of steel in the structures 110 and 120 may diminish the desired radial stabilizing forces due to the attraction of the magnets and coils to the steel. Thus, in various embodiments, it may be desirable to use a relatively thin layer of steel to assist in the assembly of the magnets and coils.

In various embodiments, as depicted in FIG. 3 for example, a non-magentizable back plate for the magnets may comprise a composite shell cylinder 260. In various additional embodiments, as illustrated in FIG. 7, a non-magnetizable black plate for the coils may comprise a composite shell cylinder 460. The shell cylinder 460 also can have teeth 461 and slots 462 to fill the interstitial space between the coils and the center of the coils, thereby providing the coils with mechanical integrity as they are mounted to the cylinder 460. Those of ordinary skill in the art would understand, however, that the above shell cylinders are exemplary only and that embodiments in accordance with the present disclosure contemplate various types and/or configurations of back plates to assist in the assembly of the magnets and coils on the rotatable and stationary structures 110 and 120. By way of example only, it may be possible to provide the individual magnetic bearing structures (e.g., each coil and magnet) with its own backing, with the structures with the individual backings being mounted to the respective rotating and/or stationary structures.

To generate electricity upon relative motion of the magnetic bearing mechanisms with respect to one another (e.g., as the rotatable structure 110 rotates about the stationary structure 120), in various additional exemplary embodiments, the lengths of the magnets and coils in the middle of the magnetic bearings mechanisms may be increased as illustrated in the exemplary embodiments of FIGS. 8-10. As shown in FIG. 8, magnetic bearing mechanisms 180 and 190 may comprise a plurality of magnets and a plurality of coils respectively, wherein the lengths of the magnets and coils positioned in the middle of a magnetic bearing mechanism array on the structures 110, 120 are longer than those positioned toward the ends of arrays on the structures 110, 120. In various embodiments, for example, magnetic bearing mechanism 180 may comprise a plurality of suspension magnets 181 and at least one generator magnet, such as, for example, three generator magnets 182, as shown in the exemplary embodiment of FIG. 8, that are positioned between the suspension magnets 181 in the middle of the magnet array. In various embodiments, as illustrated in FIG. 8, the generator magnets 182 are longer than the suspension magnets 181.

In a similar manner, magnetic bearing mechanism 190 may comprise a plurality of suspension coils 191, such as, for example, shorted coils as discussed above, and at least one generator coil 192, such as, for example, a stator winding, that is positioned between the suspension coils 191 in the middle of the coil array. In various embodiments, the at least one generator coil 191 is longer than the suspension coils 191 and extends substantially the entire length of the corresponding elongated generator magnets 182, as shown, for example, in FIG. 8.

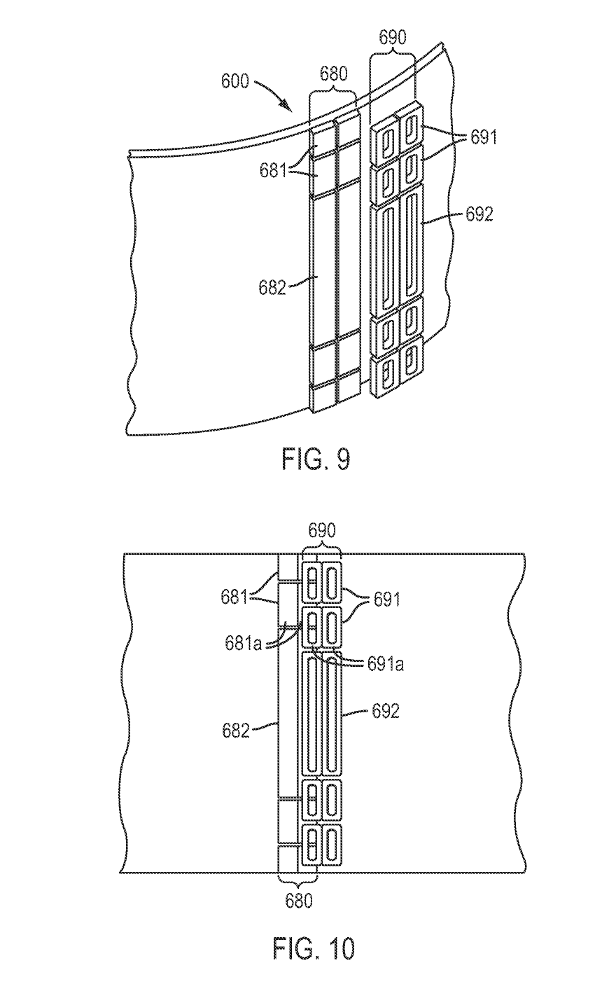

To further illustrate the position of the suspension and generator coils with respect to the suspension and generator magnets, with reference to FIGS. 9 and 10, views of an exemplary embodiment of a magnetic suspension system 600 utilizing magnetic bearing mechanisms configured for power generation in accordance with the present disclosure are shown. As illustrated in FIGS. 9 and 10, the magnetic suspension system 600 may include one or more sets of passive magnetic bearing mechanisms 680 and 690, respectively comprising suspension magnets 691 and generator magnets 692 and suspension coils 691 and generator coils 692.

As also illustrated in FIGS. 9 and 10, to produce electricity, the generator magnets 682 and generator coils 692 are longer than the suspension magnets 681 and suspension coils 691, respectively. In various exemplary embodiments, the generator magnets 682 are also longer than their corresponding generator coils 692, as perhaps best illustrated in FIG. 10. In such a configuration, when the suspension magnets 681 are displaced with respect to the suspension coils 691 (e.g., by the thrust of a fluid through the energy recovery system) the generator coils 692 will continue to shadow the generator magnets 682 and therefore produce electricity. Furthermore, when the suspension magnets 681 are displaced with respect to the suspension coils 691, the generator magnets 682 may also provide flux. For example, as shown in FIG. 10, the suspension coils 691a receive half their flux from the suspension magnets 681a and half their flux from the generator magnets 682. Thus, a portion of the generator magnets 682 may also provide flux for the suspension coils 691a.

As would be understood by those of ordinary skill in the art, as used herein the terms “suspension magnets” and “suspension coils” refer to magnets and coils, as discussed above with reference to the embodiments of FIGS. 1-5, that are configured and positioned to provide both axial restoring and radial stabilizing forces. Wherein, as used herein the terms “generator magnets” and “generator coils” refer respectively to magnets and coils that are configured and positioned to produce electricity as the magnetic bearing mechanisms move with respect to one another, and which provide little, if any, axial restoring and radial stabilizing forces.

For underwater power generation applications as disclosed in the present disclosure, for example, the electricity generated by the generator coils may be fed to a convertor, which may consist, for example, of a rectifier (not shown) and an inverter (not shown). As would be understood by those of ordinary skill in the art, such devices may typically have a power factor of about 0.95, which may fall substantially in phase with the induced current of the generator coils. By contrast, the current induced in the suspension coils is approximately 90 degrees out of phase with the current of the generator coils. Thus, the in-phase current of the generator coils will have little, if any, axial restoring or repulsive force. Furthermore, various exemplary embodiments of the present disclosure contemplate making the length of generator magnets longer than the generator coils (see, e.g., FIGS. 9 and 10), which may also suppress axial force components of the generator coils.

As above, the magnetic bearing mechanisms 180 and 190 may comprise various types and/or configurations of magnets and coils, and those having skill in the art would understand how to modify and offset the bearing mechanisms 180 and 190 with respect to each other to permit the rotatable structure 110 to rotate relative to the stationary structure 120 in a substantially stable axial position and a substantially stable radial position by providing a sufficient axial restoring force and radial lift force. Those having ordinary skill in the art would further understand how to determine, such as, for example, through magnetic field analysis, the number and/or dimensions of the generator magnets and generator coils needed to generate a required power output for a desired application.

An exemplary method of recovering fluid flow (e.g., current) energy in accordance with an exemplary embodiment of the present disclosure is set forth in the following description with reference to the embodiments of FIGS. 1, 2, and 8. An energy recovery system 100 may be placed in a liquid fluid body (such as, e.g., water), wherein the energy recovery system 100 comprises a rotatable structure 110 and a stationary structure 120. As above, the rotatable structure 110 is configured to rotate relative to the stationary structure 120 and defines an axis of rotation A. The energy recovery system 100 may further comprise at least one magnetic bearing mechanism 140, 150, 180, 190 having a plurality of magnets 145, 181, 182 and coils 150, 191, 192.

In accordance with various embodiments of the present disclosure, the at least one magnetic bearing mechanism 140, 150, 180, 190 is disposed to provide a radial and axial bearing (suspension) between the rotatable structure 110 and the stationary structure 120 as the rotatable structure 110 rotates about the stationary structure. In various embodiments, for example, the at least one magnetic bearing mechanism 140, 150, 180, 190 is disposed to provide an axial restoring force between the rotatable structure 110 and the stationary structure 120 as the rotatable structure 110 rotates about the stationary structure 120. In various additional embodiments, the at least one bearing mechanism 140, 150, 180, 190 is disposed to provide a radial stabilizing force between the rotatable structure 110 and the stationary structure 120 as the rotatable structure 110 rotates about the stationary structure 120.

The energy recovery system 100 may be oriented in the fluid body so that the fluid currents FC_{A} and FC_{B} in the fluid body may flow in a direction having a component that is substantially parallel to the axis of rotation A of the rotatable structure 110 to cause rotation of the rotatable structure 110. In various embodiments, for example, the energy recovery system 100 may further comprise at least one blade member 130 mounted to and extending radially outward from the rotatable structure 110 such that the fluid currents FC_{A} and FC_{B} interact with the at least one blade member 130 to cause rotation of the rotatable structure 110.

At least one of electricity and hydrogen may then be generated by movement of at least one magnetic field source relative to an electrically conductive element during the rotation of the rotatable structure 110. In various exemplary embodiments of the present disclosure, for example, as illustrated in FIG. 8, the plurality of magnets 181, 182 for the magnetic bearing mechanism 180 may comprise the magnetic field source (e.g., via generator magnets 182). In various additional exemplary embodiments, the plurality of coils 191, 192 for the magnetic bearing mechanism 190 may comprise the electrically conductive element (e.g., via generator coils 192).

The exemplary embodiments of FIGS. 1-10 are non-limiting and those having ordinary skill in the art will appreciate that modifications may be made to the arrangements and configurations depicted without departing from the scope of the present disclosure. Those of ordinary skill in the art would further appreciate that although the present disclosure as been discussed in terms of energy recovery systems comprising rotating and stationary structures, such as, for example, illustrated in FIGS. 1, 2 and 8, that magnetic suspension systems, including magnetic bearing mechanisms of the present disclosure, may be incorporated into various rotating structures as would be understood by those of ordinary skill in the art, and are not limited to the energy recovery systems disclosed herein.

Furthermore, various mechanisms also may be used to convert to electricity or other useful forms of energy the rotational motion of the rotatable structures relative to the stationary structures in accordance with various exemplary embodiments of the present disclosure. Such mechanisms may include, but are not limited to, the use of hydraulic pumps, rotating drive shafts, etc. Reference is made to U.S. Pat. Nos. 7,453,166 and 7,604,454, incorporated by reference herein, for examples of various techniques that may be used to convert the rotational movement of a structure to other useful forms of energy. Ordinarily skilled artisans would understand how to modify the various techniques disclosed in U.S. Pat. Nos. 7,453,166 and 7,604,454 to adapt those techniques for use with the energy recovery systems in accordance with the present disclosure.

In various exemplary embodiments, energy recovery systems of the present disclosure include blade members that extend both radially outwardly and radially inwardly from the rotatable structure respectively away from and toward a center of the rotatable structure. However, energy recovery systems may include blade members that extend only radially outwardly or only radially inwardly. In embodiments wherein the blade members extend both radially outwardly and radially inwardly, the blade members may comprise integral structures or separate structures mounted to the rotatable structure. In various exemplary embodiments, the blade member extending radially outwardly and the blade member extending radially inwardly may be asymmetrical about the rotatable structure. For example, a length of the blade member extending radially outwardly may be longer than a length of the blade member extending radially inwardly; alternatively, the blade members extending radially outward and the radial inward may be symmetrical about the rotatable structure. The length of blade members extending radially inwardly may be chosen such that those blade members minimize interference with the fluid flowing through the center of the energy conversion system.

In various exemplary embodiments, the blade members may be fixed or adjustable relative to the rotatable structure. For example, for adjustable blade members, the blade members may be rotatable about their longitudinal axis so as to adjust an angle of the blade member surface relative to the fluid flow. Reference is made to U.S. Pat. No. 7,453,166, incorporated by reference herein, for further details relating to adjustable blade members.

Those having ordinary skill in the art will recognize that various modifications may be made to the configuration and methodology of the exemplary embodiments disclosed herein without departing from the scope of the present disclosure. By way of example only, the cross-sectional shaped and relative sizes of the rotatable structures and the stationary structures may be modified and a variety of cross-sectional configurations may be utilized, including, for example, circular or oval cross-sectional shapes.

Moreover, although the orientation of the energy conversion systems in the various exemplary embodiments described herein is generally within a substantially vertical plane, those ordinarily skilled in the art will appreciate that modifications may be made to operate energy conversion systems in accordance with the present disclosure in any orientation.

Those having ordinary skill in the art also will appreciate that various features disclosed with respect to one exemplary embodiment herein may be used in combination with other exemplary embodiments with appropriate modifications, even if such combinations are not explicitly disclosed herein.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the systems and methods of the present disclosure without departing from the scope the present disclosure and appended claims. Other embodiments of the disclosure will be apparent to those skilled in the art from consideration of the specification and practice of the disclosure disclosed herein. It is intended that the specification and examples be considered as exemplary only.

What is claimed is:

1. An energy recovery system comprising:
a stationary structure;
a rotatable structure configured to rotate relative to the stationary structure about an axis of rotation;
at least one blade member mounted to and extending radially outward from the rotatable structure, the at least one blade member being configured to interact with fluid currents flowing in a direction substantially parallel to the axis of rotation to cause the rotatable structure to rotate about the axis of rotation; and
a magnetic suspension system comprising a plurality of magnets and a plurality of coils, wherein the plurality of magnets and the plurality of coils provide a magnetic force that substantially maintains an axial and radial position of the rotatable structure and the stationary structure as the rotatable structure rotates about the stationary structure.

2. The energy recovery system of claim 1, wherein the plurality of magnets and the plurality of coils provide an alignment force between the rotatable structure and the stationary structure.

3. The energy recovery system of claim 1, wherein the plurality of magnets and the plurality of coils provide a repulsive force between the rotatable structure and the stationary structure.

4. The energy recovery system of claim 1, wherein the plurality of magnets are coupled to the rotatable structure.

5. The energy recovery system of claim 4, wherein the plurality of coils are coupled to the stationary structure.

6. The energy recovery system of claim 1, wherein the plurality of magnets are substantially arranged in a Halbach type array.

7. The energy recovery system of claim 1, wherein the plurality of coils are shorted coils.

8. The energy recovery system of claim 1, wherein the plurality of magnets comprise a plurality of suspension magnets and at least one generator magnet disposed between the suspension magnets, wherein the at least one generator magnet is longer than the suspension magnets.

9. The energy recovery system of claim 8, wherein the plurality of coils comprise a plurality of shorted coils and at least one generator coil disposed between the shorted coils, wherein the at least one generator coil is longer than the shorted coils.

10. The energy recovery system of claim 1, wherein each coil comprises a plurality of turns, and wherein at least one of the turns is surrounded by a ferromagnetic sleeve.

11. The energy recovery system of claim 1, wherein the system is configured to convert rotation of the rotatable structure to at least one of electricity and hydrogen production.

12. A method of supporting a rotating structure, the method comprising:
rotating a rotating structure relative to a stationary structure about an axis of rotation, wherein the rotating causes relative movement of a magnetic field source and an electrically conductive element; and
generating a magnetic force resulting from the relative movement of the magnetic field source and electrically conductive element, wherein the magnetic force is sufficient to substantially maintain a position of the rotatable structure relative to the stationary structure during the rotating.

13. The method of claim 12, further comprising generating at least one of electricity and hydrogen.

14. The method of claim 13, wherein the generating of the at least one of electricity and hydrogen comprises generating at least one of electricity and hydrogen by movement of the least one magnetic field source relative to the electrically conductive element during the rotating of the rotatable structure.

15. The method of claim 12, wherein the rotating of the rotating structure occurs by fluid flow interacting with the rotating structure.

16. The method of claim 12, wherein the generating the magnetic force comprises generating an axial force and a radial force to substantially maintain the position of the rotating structure relative to the stationary structure.

17. The method of claim 12, further comprising inducing a magnetic force in the electrically conductive element via the relative movement of the magnetic field source and electrically conductive element.

18. The method of claim 17, wherein the inducing the magnetic force causes the magnetic field source and electrically conductive element to align to a position where no net magnetic flux is linked between the magnetic field source and electrically conductive element.

19. The method of claim 12, wherein generating the magnetic force comprises generating a repulsive magnetic force between the magnetic field source and the electrically conductive element.

20. The method of claim 19, wherein generating the repulsive magnetic force produces a radial force that levitates the rotating structure relative to the stationary structure.
